(19) United States
(12) Patent Application Publication
(10) Pub. No.: US 2026/0214035 A1
(43) Pub. Date: Jul. 23, 2026

(54) PRE-AGGREGATED DATA TABLES FOR NETWORKING DEVICE MONITORING SYSTEMS

(71) Applicant: Aviz Networks, Inc., San Jose, CA (US)

(72) Inventors: Chidambaram Bhagavathiperumal, Livermore, CA (US); Kuldip Patel, Rajkot (IN)

(73) Assignee: Aviz Networks, Inc., San Jose, CA (US)

(21) Appl. No.: 19/034,543

(22) Filed: Jan. 22, 2025

(51) Int. Cl. H04L 43/067; H04L 41/0654; H04L 43/045

(52) U.S. Cl. CPC H04L 43/067; H04L 41/0654; H04L 43/045

(57) ABSTRACT

A system and method for improving data processing efficiency in networking device monitoring systems by introducing pre-aggregated data tables. This approach minimizes the need to scan raw data during queries, thus enhancing query performance and system efficiency.

### BACKGROUND

Traditional networking device monitoring systems are struggling to keep up with rapidly increasing data volumes and the widespread adoption of cloud services. Conventional methods require extensive time to locate accurate results, particularly when visualizing and querying large datasets across multiple time frames. What is needed is a method to improve query performance in networking device monitoring systems.

### SUMMARY

The present disclosure addresses these challenges by using pre-aggregated data tables for monitoring networking devices. Embodiments of the present disclosure store summarized data in specific tables. It can be appreciated that such an approach reduces the need to go through all the raw data every time, thus speeding up the process of finding information and making the system more efficient overall.

The present disclosure further provides an innovative solution for real-time aggregation and performance monitoring of high-scale network data streams. By introducing pre-aggregated data structures, the system addresses the inefficiencies of querying large datasets and reduces the computational burden of on-the-fly aggregations. The dynamic aggregation engine enables efficient querying and visualization of network performance data while supporting real-time anomaly detection and automated corrective actions.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In one general aspect, method may include receiving raw telemetry data by a network management interface client to create ingested raw telemetry data. Method may also include processing the ingested raw telemetry data into one or more pre-aggregated streams across time windows. Method may furthermore include storing the one or more pre-aggregated streams across a plurality of time windows into a dynamic storage device, where the dynamic storage device includes separate tables for different time intervals, including metadata for aggregation levels. Method may in addition include dynamically calculating one or more aggregation intervals based on the plurality of time windows and a required number of points and automatically choosing a granularity. Method may moreover include querying the one or more pre-aggregated stream for analytics, anomaly detection, and visualization. Other embodiments of this aspect include corresponding computer systems, apparatus, and computer programs recorded on one or more computer storage devices, each configured to perform the actions of the methods.

In one general aspect, non - transitory computer - readable medium may include one or more instructions that, when executed by one or more processors of a device, cause the device to: receive raw telemetry data by a network management interface client to create ingested raw telemetry data; process the ingested raw telemetry data into one or more pre-aggregated streams across time windows; store the one or more pre-aggregated streams across a plurality of time windows into a dynamic storage device, where the dynamic storage device includes separate tables for different time intervals, including metadata for aggregation levels; dynamically calculate one or more aggregation intervals based on the plurality of time windows and a required number of points and automatically choosing a granularity; query the one or more pre-aggregated stream for analytics, anomaly detection, and visualization. Other embodiments of this aspect include corresponding computer systems, apparatus, and computer programs recorded on one or more computer storage devices, each configured to perform the actions of the methods.

In one general aspect, system may include one or more processors configured to:. System may also include receive raw telemetry data by a network management interface client to create ingested raw telemetry data. System may furthermore include process the ingested raw telemetry data into one or more pre-aggregated streams across time windows. System may in addition include store the one or more pre-aggregated streams across a plurality of time windows into a dynamic storage device, where the dynamic storage device includes separate tables for different time intervals, including metadata for aggregation levels. System may moreover include dynamically calculate one or more aggregation intervals based on the plurality of time windows and a required number of points and automatically choosing a granularity. System may also include query the one or more pre-aggregated stream for analytics, anomaly detection, and visualization. Other embodiments of this aspect include corresponding computer systems, apparatus, and computer programs recorded on one or more computer storage devices, each configured to perform the actions of the methods.

### DETAILED DESCRIPTION

According to an embodiment of the present disclosure an aggregated stream generation engine is provided to generate aggregated data structures. The aggregated data structures are configured to summarize data for monitoring operations of one or more computer systems of a high-scale network (e.g., data centers, server farms, etc.). An aggregated data stream representing the performance data can be used to monitor or detect anomalies by consuming the aggregated stream. In response, a corrective action can be taken to address the issue. This can be useful, for example, in improving the efficiency, effectiveness, and reliability of a high-scale network in a large data center that hosts thousands of servers and network devices, all interconnected to handle massive amounts of data traffic. This data center supports various services such as cloud computing, storage solutions, and real-time data processing for global clients. By utilizing the aggregated stream generation engine, the data center can efficiently monitor network performance, quickly detect any anomalies, and implement automated corrective actions to ensure seamless service delivery and optimal network reliability.

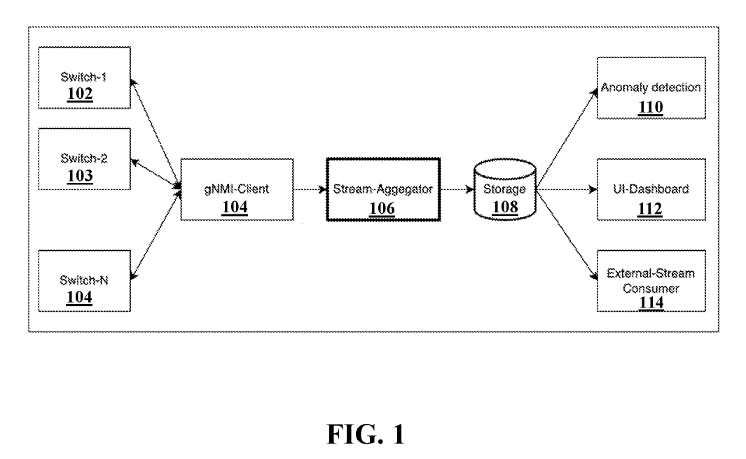

A system architecture 100 is shown in FIG. 1. In this system architecture 100, Switches 101, 102, and 103 are responsible for sending raw telemetry data to a gNMI-Client 104. These switches include enterprise-grade switches known for their high performance and reliability. According to an embodiment, a gNMI-Client is a network management interface client that collects, processes, and formats telemetry data from network devices. The gNMI-Client then processes and inputs this data into the stream-aggregator 106. The stream-aggregator 106 functions by collecting and organizing telemetry data into structured formats before storing it in storage unit 108. The stream-aggregator can be deployed on the same high-performance machine as the gNMI-Client or on a separate device within the network infrastructure. According to an embodiment of the present disclosure, deploying the stream aggregator on a separate device is utilized to distribute the computational load and enhance scalability, thus ensuring that the system can handle increasing data volumes effectively.

According to an embodiment of the present disclosure, the gNMI-Client is equipped with a high-performance multi-core processor to ensure it can handle the intensive computations required for real-time data processing. It also features substantial memory, for example according to an embodiment DDR5 RAM with capacities ranging from 512GB to 2TB (or above), to efficiently manage large datasets and perform in-memory computations. Additionally, the gNMI-Client includes multiple high-speed network interface cards (NICs) to facilitate rapid data acquisition and transmission, ensuring seamless communication between network devices and the monitoring system. According to one embodiment, the architecture might include use of additional gRPC Network Management Interface (gNMI) clients such as gNMI-Client 104 for collecting raw telemetry data from network switches and devices.

The stream-aggregator is implemented according to an embodiment using frameworks like Apache Kafka, which handles the real-time data streams, or Apache Flink, which processes the data as it arrives. This allows for efficient handling and transformation of data, ensuring quick and reliable updates to the storage unit. For instance, in a large-scale data center, the stream-aggregator can continuously receive telemetry data from thousands of network devices, aggregate it in real-time, and feed it into the storage systems to facilitate immediate analysis and monitoring across the network infrastructure. Data aggregation can be handled according to an embodiment using stream processing frameworks such as Apache Kafka and Apache Flink to facilitate real-time data aggregation and processing. According to an embodiment, the architecture further includes utilization of scalable storage solutions like NoSQL databases to store the raw and pre-aggregated data. These NoSQL databases are optimized for high write throughput and horizontal scalability.

The architecture can efficiently handle the dynamic aggregation, storage, and analysis of large-scale network data streams, thereby enhancing overall system performance and reliability. Within the storage unit, the data is maintained in the pre-aggregated data tables is designed to enhance querying efficiency. These pre-aggregated tables significantly reduce the need to fully scan raw data which then results in faster and more efficient data retrieval. Next, according to an embodiment of the present disclosure, the stored data is then utilized by several key components:

Anomaly Detection Engine 110 uses the pre-aggregated data to detect anomalies in real-time. By leveraging pre-aggregated streams across various time windows, it can identify irregularities and facilitate automated corrective actions to improve network performance.

UI Dashboard 112 displays the aggregated and processed data for monitoring and analysis purposes. It provides network administrators with insights and visual representations of network performance metrics.

External Stream Consumer 114 external applications or systems to consume the aggregated data streams. It ensures interoperability and the seamless integration of the monitoring system with other external platforms.

Together, these components shown in FIG. 1 help to form a comprehensive system that enhances data processing efficiency in networking device monitoring systems by utilizing pre-aggregated data tables in a structured design which is configured to handle massive data volumes with faster data processing capability than conventional approaches. According to an embodiment of the present disclosures, the anomaly detection can include machine learning algorithms using frameworks such as TensorFlow or PyTorch to detect anomalies in the aggregated data. These algorithms can be integrated into the anomaly detection engine to provide real-time insights and automated corrective actions.

The architecture may also include use of RESTful APIs or gRPC services to facilitate interaction between the External Stream Consumer 114 and other external applications, ensuring seamless data consumption and interoperability. For example, performance monitoring tools like Prometheus can ingest the aggregated data to provide detailed metrics and alerts. Similarly, data visualization platforms such as Grafana can use the data for creating real-time dashboards, aiding in the visual representation of network health. Additionally, machine learning platforms like TensorFlow can consume the aggregated data to train models for predictive analytics and anomaly detection.

The aggregated stream generation engine is configured to generate aggregated data structures to summarize data for monitoring operations of one or more computer systems of a high-scale network (e.g., data centers, server farms, etc.). The aggregated data stream representing the performance data can be used to monitor or detect anomalies by consuming the aggregated stream. In response, a corrective action can be taken to address the issue. This corrective action can then be monitored and logged for improving the efficiency, effectiveness, and reliability of the computer system during operation.

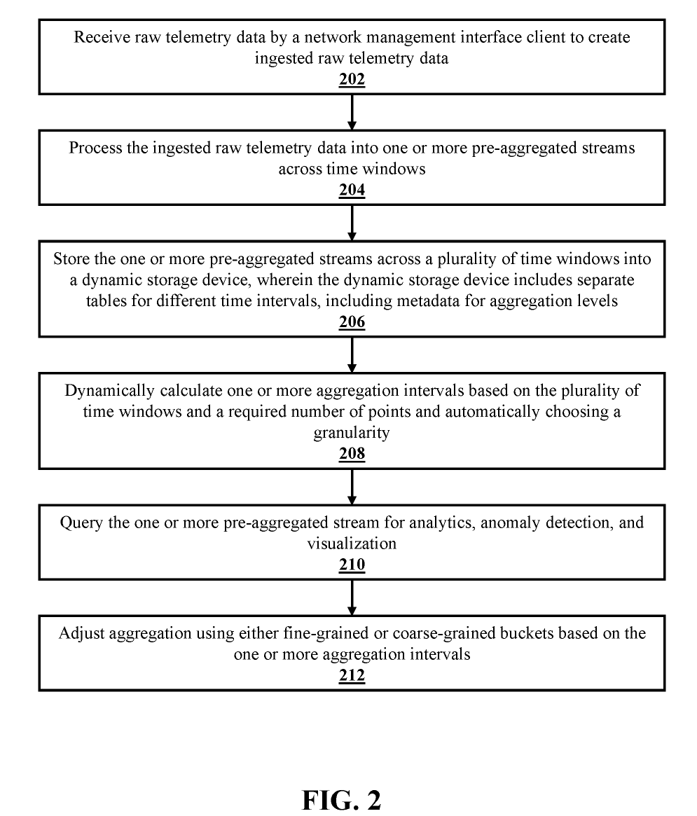

FIG. 2 is a flowchart of an example process 200. In some implementations, one or more process blocks of FIG. 2 may be performed by a device .

As shown in FIG. 2, process 200 may include receiving raw telemetry data by a network management interface client to create ingested raw telemetry data (block 202). An example implementation could involve a data center using a gNMI-Client to collect telemetry data from thousands of network switches and devices.

As also shown in FIG. 2, process 200 may include processing the ingested raw telemetry data into one or more pre-aggregated streams across time windows (block 204). An example implementation could involve using Apache Kafka to handle the pre-aggregated streams data streams and Apache Flink to process and aggregate the data in real-time.

As further shown in FIG. 2, process 200 may include storing the one or more pre-aggregated streams across a plurality of time windows into a dynamic storage device, where the dynamic storage device includes separate tables for different time intervals, including metadata for aggregation levels (block 206). For example, an implementation could involve using a NoSQL database such as Apache Cassandra to store the pre-aggregated data in a distributed and highly available manner, ensuring quick access and efficient querying of network performance metrics, where the NoSQL database includes separate tables for different time intervals, including metadata for aggregation levels, as described above.

As also shown in FIG. 2, process 200 may include dynamically calculating one or more aggregation intervals based on the plurality of time windows and a required number of points and automatically choosing a granularity (block 208). For example, an implementation could involve using a sliding window algorithm to adjust the aggregation intervals based on real-time data flow and network performance requirements and a required number of points and automatically choosing a granularity, as described above.

As further shown in FIG. 2, process 200 may include querying the one or more pre-aggregated stream for analytics, anomaly detection, and visualization (block 210). For example, the device may query the one or more pre-aggregated streams to generate insights for performance metrics, detect anomalies, and provide visualizations on dashboards for network administrators.

To enhance the visualization capabilities, UI Dashboard 112 can include customizable widgets, allowing users to create tailored views of network performance. These widgets can display various metrics such as latency, packet loss, and throughput, helping administrators quickly identify and address issues.

Additionally, process 200 can integrate visualization tools like Grafana to create interactive and real-time dashboards, enabling a comprehensive view of the network's health. These dashboards can include charts, graphs, and alerts that provide immediate feedback on network performance and anomalies.

Furthermore, the architecture can support the implementation of advanced visualization techniques, such as heat maps and topological maps, to represent data spatially and temporally. This aids in understanding network behavior and identifying patterns over different time intervals.

Process 200 may include additional implementations, such as any single implementation or any combination of implementations described below and/or in connection with one or more other processes described elsewhere herein. A first implementation, process 200 may include adjusting aggregation using either fine-grained or coarse-grained buckets based on the one or more aggregation intervals.

In a second implementation, alone or in combination with the first implementation, the dynamic storage device utilizes one or more separate tables for a plurality of time intervals, including a plurality of metadata for aggregation levels, and limiting record counts per device by a predetermined limit amount.

A third implementation, alone or in combination with the first and second implementation, process 200 may include detecting in real-one or more anomalies using the one or more pre-aggregated streams across the plurality of time windows and facilitating automated corrective actions for improved network performance.

In a fourth implementation, alone or in combination with one or more of the first through third implementations, an additional column identifies the plurality of time windows.

Although FIG. 2 shows example blocks of process 200, in some implementations, process 200 may include additional blocks, fewer blocks, different blocks, or differently arranged blocks than those depicted in FIG. 2. Additionally, or alternatively, two or more of the blocks of process 200 may be performed in parallel.

According to an embodiment of the present disclosure, the system ingests and stores raw telemetry data as-is. For pre-aggregated data storage, aggregated data is stored separately for different time windows, with an additional column identifying the aggregation level (e.g., minute, hour). The process involves a detailed description of the data aggregation procedure and the storage structure of pre-aggregated data tables.

The architecture’s scalability ensures its applicability to networks of varying sizes, from small deployments to large-scale data centers. This invention significantly improves the speed, efficiency, and reliability of network monitoring processes, making it an essential advancement for modern data centers and cloud infrastructure.

The process involves dynamically calculating aggregation intervals based on the selected time range and the required number of points. For example, short time ranges such as one hour use fine-grained buckets, while longer time ranges like a week use coarser buckets.

Fine-grained buckets refer to smaller intervals of data aggregation, providing a more detailed and granular view of the network's performance metrics. These are particularly useful for short-term monitoring, where precise and frequent data points are necessary to identify sudden anomalies or variations in performance. For instance, in a one-hour monitoring window, data might be aggregated in one-minute intervals, allowing for a thorough analysis of minute-by-minute changes.

Coarser-grained buckets, on the other hand, involve larger intervals of aggregation, which summarize data over extended periods. This approach is suitable for long-term monitoring and trend analysis, where the focus is on broader patterns rather than immediate fluctuations. In a week-long monitoring scenario, data could be aggregated in hourly intervals, providing a comprehensive overview without overwhelming the system with excessive data points.

The implementation of these bucket types involves dynamically adjusting the aggregation interval based on the monitoring window selected by the user. According to an embodiment, the system automatically chooses the appropriate granularity, ensuring efficient data processing and storage. Fine-grained buckets are employed for short-term, detailed analyses, while coarser-grained buckets are used to maintain the balance between data volume and analytical depth over longer monitoring periods.

Key advantages include efficient querying by directly accessing precomputed results and reducing the need for computationally expensive on-the-fly aggregations. In terms of storage optimization, according to an embodiment of the present disclosure the number of records per device is fixed for each aggregation level, ensuring that storage requirements grow linearly with the number of devices, making the system scalable for large deployments.

This approach also offers several other benefits. By leveraging pre-aggregated data, the system can significantly enhance the performance of networking device monitoring systems. Query execution times are drastically improved, resulting in faster insights and more responsive monitoring. Moreover, the reduction in processing time enables the system to handle larger volumes of data without compromising on speed or efficiency. Ultimately, this leads to a more robust and reliable network infrastructure, capable of supporting modern data centers and cloud-based environments.

1. A method, comprising:
receiving raw telemetry data by a network management interface client to create ingested raw telemetry data;
processing the ingested raw telemetry data into one or more pre-aggregated streams across time windows;
storing the one or more pre-aggregated streams across a plurality of time windows into a dynamic storage device, wherein the dynamic storage device includes separate tables for different time intervals, including metadata for aggregation levels;
dynamically calculating one or more aggregation intervals based on the plurality of time windows and a required number of points and automatically choosing a granularity;
querying the one or more pre-aggregated stream for analytics, anomaly detection, and visualization.

2. The method of claim 1, further comprising adjusting aggregation using either fine-grained or coarse-grained buckets based on the one or more aggregation intervals.

3. The method of claim 2, wherein the dynamic storage device utilizes one or more separate tables for a plurality of time intervals, including a plurality of metadata for aggregation levels, and limiting record counts per device by a predetermined limit amount.

4. The method of claim 3, further comprising detecting in real-one or more anomalies using the one or more pre-aggregated streams across the plurality of time windows and facilitating automated corrective actions for improved network performance.

5. The method of claim 1, wherein an additional column identifies the plurality of time windows.

6. A non-transitory computer-readable medium storing a set of instructions, the set of instructions comprising:
one or more instructions that, when executed by one or more processors of a device, cause the device to:
receive raw telemetry data by a network management interface client to create ingested raw telemetry data;
process the ingested raw telemetry data into one or more pre-aggregated streams across time windows;
store the one or more pre-aggregated streams across a plurality of time windows into a dynamic storage device, wherein the dynamic storage device includes separate tables for different time intervals, including metadata for aggregation levels;
dynamically calculate one or more aggregation intervals based on the plurality of time windows and a required number of points and automatically choosing a granularity;
query the one or more pre-aggregated stream for analytics, anomaly detection, and visualization.

7. The non-transitory computer-readable medium of claim 6, wherein the one or more instructions further cause the device to:
adjust aggregation using either fine-grained or coarse-grained buckets based on the one or more aggregation intervals.

8. The non-transitory computer-readable medium of claim 7, wherein the dynamic storage device utilizes one or more separate tables for a plurality of time intervals, including a plurality of metadata for aggregation levels, and limiting record counts per device by a predetermined limit amount.

9. The non-transitory computer-readable medium of claim 8, wherein the one or more instructions further cause the device to:
detect in real-one or more anomalies using the one or more pre-aggregated streams across the plurality of time windows and facilitating automated corrective actions for improved network performance.

10. The non-transitory computer-readable medium of claim 6, wherein an additional column identifies the plurality of time windows.

11. A system comprising:
one or more processors configured to:
receive raw telemetry data by a network management interface client to create ingested raw telemetry data;
process the ingested raw telemetry data into one or more pre-aggregated streams across time windows;
store the one or more pre-aggregated streams across a plurality of time windows into a dynamic storage device, wherein the dynamic storage device includes separate tables for different time intervals, including metadata for aggregation levels;
dynamically calculate one or more aggregation intervals based on the plurality of time windows and a required number of points and automatically choosing a granularity;
query the one or more pre-aggregated stream for analytics, anomaly detection, and visualization.

12. The system of claim 11, wherein the one or more processors are further configured to:
adjust aggregation using either fine-grained or coarse-grained buckets based on the one or more aggregation intervals.

13. The system of claim 12, wherein the dynamic storage device utilizes one or more separate tables for a plurality of time intervals, including a plurality of metadata for aggregation levels, and limiting record counts per device by a predetermined limit amount.

14. . The system of claim 13, wherein the one or more processors are further configured to:
detect in real-one or more anomalies using the one or more pre-aggregated streams across the plurality of time windows and facilitating automated corrective actions for improved network performance.

15. The system of claim 14, wherein an additional column identifies the plurality of time windows.
